(19) United States
(12) Patent Application Publication
(10) Pub. No.: US 2026/0166944 A1
(43) Pub. Date: Jun. 18, 2026

(54) Heating Circuit and Method for Operating a Heating Circuit

(71) Applicant: MAHLE International GmbH, Stuttgart (DE)

(72) Inventor: Sascha Lindauer, Schorndorf (DE)

(21) Appl. No.: 19/420,504

(22) Filed: Dec. 15, 2025

(30) Foreign Application Priority Data
Dec. 17, 2024 (DE) 102024138369.0

(51) Int. Cl. B60H 1/00; B60H 1/32

(52) U.S. Cl. CPC B60H 1/00385; B60H 1/00914; B60H 1/3205; B60H 2001/325; B60H 2001/3272; B60H 2001/3285

(57) ABSTRACT

A heating circuit, specifically for a motor vehicle is provided. The heating circuit has a compressor, a first heat exchanger functioning as a heater, a second heat exchanger functioning as a chiller, at least two expansion valves, wherein the compressor has an intake and an outlet, the first heat exchanger has a first intake and first outlet, and the second heat exchanger has a second intake and second outlet, wherein the outlet on the compressor is connected to the first intake, the first outlet is connected to the second intake, and the second outlet is connected to the intake on the compressor, wherein there is a first expansion valve upstream of the second heat exchanger (4) and wherein a bypass is formed between the outlet and the intake on the compressor, in which the second expansion valve is located.

### CROSS-REFERENCE TO RELATED APPLICATIONS

This application claims priority from German Patent Application No. 102024138369.0, filed on Dec. 17, 2024, the entirety of which is hereby incorporated by reference herein.

The invention relates to a heating circuit and a method for operating such a heating circuit, particularly for a motor vehicle.

Heating passenger compartments and various units in motor vehicles, particularly electric vehicles, is of special importance, because with hybrid vehicles, the internal combustion engine provides very little exhaust heat, and with purely electric vehicles, there is no internal combustion engine, such that any heat must be provided from elsewhere.

The object of the present invention is to create an effective heating circuit with which a vehicle can be easily and effectively heated, and to create a method for effectively using the improved heating circuit, and to effectively start the heating circuit.

The heating circuit object is achieved with the features of Numbered Paragraph 1.

The heating circuit, specifically for a motor vehicle, contains a compressor, a first heat exchanger in the form of a heater, a second heat exchanger in the form of a chiller, and at least two expansion valves, in which the compressor has an intake and an outlet, the first heat exchanger has a first intake and first outlet, and the second heat exchanger has a second intake and second outlet, the compressor outlet is connected to the first intake, the first outlet is connected to the second intake, and the second outlet is connected to the compressor's intake, a first expansion valve is upstream of the second heat exchanger, and there is a bypass between the compressor's outlet and intake in which there is a second expansion valve. This results in an effective heating of a vehicle without the need for exhaust heat from an internal combustion engine.

A third expansion valve downstream of the compressor and upstream of the first heat exchanger is also advantageous. This allows for a third option for effectively operating the heat circuit.

Ideally, the heating circuit is operated with a refrigerant, in particular without fluorides, e.g. CO₂, propane, R134, R1234yf, etc. As such, modern refrigerants can be used, particularly if those containing fluorides are banned in the future.

The first heat exchanger is ideally a refrigerant/air heat exchanger that heats the air supplied to the vehicle cab. This forms an effective means of heating the passenger compartment.

The first heat exchanger can also be a refrigerant/liquid heat exchanger that is connected to a liquid circuit containing a liquid/air heat exchanger for heating the air supplied to the vehicle cab. This forms an alternative means for effectively heating the passenger compartment.

Ideally, the liquid is a water-based refrigerant. This type of refrigerant is readily available, inexpensive, easy to dispose of, and can also contain an antifreeze.

The second heat exchanger is ideally a chiller in the form of a refrigerant/liquid heat exchanger in which the liquid is preferably a water-based coolant. In this case, the chiller transfers heat and can also be used as a source of heat at a low temperature, e.g. for a battery.

The object with regard to the method is obtained with the features of Numbered Paragraph 8.

This method is used to control a heating circuit that contains at least one compressor, a first expansion valve, a second expansion valve, and potentially a third expansion valve, in which the compressor and the first, second and potentially third expansion valves are used to control the heating circuit, in particular its thermal output. Consequently, the heating circuit can be operated in different phases in order to obtain a continuous operation that is efficient, effective and capable of producing a substantial amount of heat.

Ideally, the heating circuit is operated in different phases, including at least a first, preparatory phase, a second, initial heating phase, a third, initial heating phase, and a fourth, continuous operating phase. These phases can be used to start the operation of the heating circuit and operate it continuously.

The pressure prior to reaching the compressor is ideally limited in the first phase, the preparatory phase, by the rotational rate of the compressor, in which the second expansion valve is partially closed.

Ideally, the first expansion valve is also partially closed, and the third is shut off. Consequently, the refrigerant only flows substantially through the starting circuit, or bypass circuit, in the first phase, such that it passes through the compressor and the bypass. As a result, the refrigerant is pressurized to a target pressure and thus heated, such that it is easier to heat and pressurize in subsequent phases.

It is also advantageous when the first expansion valve regulates overheating at the compressor's outlet during the second phase, i.e. the initial heating phase, in which the second expansion valve is partially open, and the third starts to open, such that the compressor regulates the heat output. This forms the transition from the starting circuit to the larger overall circuit.

It is also advantageous when the first expansion valve regulates overheating at the compressor's outlet in the third phase, i.e. the initial heating phase, in which the second expansion valve is partially open to alter the flow in order to regulate the pressure at the compressor's intake, the third expansion valve is open, and the heat output is regulated by the compressor's rotational rate. This is in preparation for continuous operation.

Overheating at the compressor's outlet is ideally regulated in the fourth phase, i.e. the continuous operation, by the first expansion valve, the pressure at the compressor's intake is regulated by the second expansion valve, the third expansion valve is open, and the heat output is regulated by the compressor's rotational rate. This results in a more effective continuous operation.

The target value A for the initial pressure at the compressor's outlet is ideally:

$$C + 1 bar < A < C + 3 bar$$

in which C is the pressure at the compressor's outlet at the end of the first phase.

It is also advantageous when the value C for the pressure at the compressor's outlet at the end of the first phase is:

$$C < B + 2 bar , or B - 2 bar < C < B + 4 bar$$

in which B is a predefined specific value for the regulating circuit forming the final value for the pressure at the compressor's outlet.

The value D, which is the extent to which the third expansion valve is open at the start of the third phase, is ideally:

$$D > 50 \% or D > 70 \% .$$

The invention shall be explained in greater detail below in reference to the drawings, based on exemplary embodiments.

Therein:

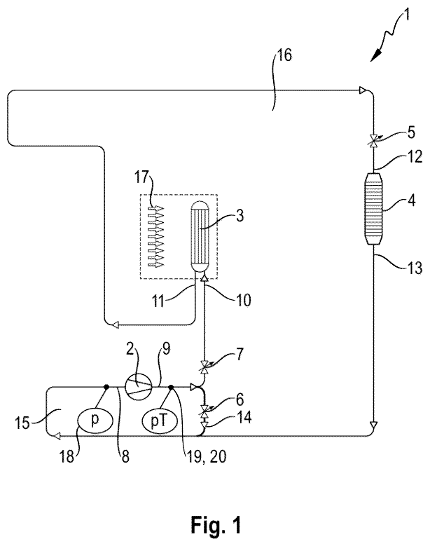

FIG. 1 shows a schematic drawing of an exemplary embodiment of a heating circuit obtained with the invention,

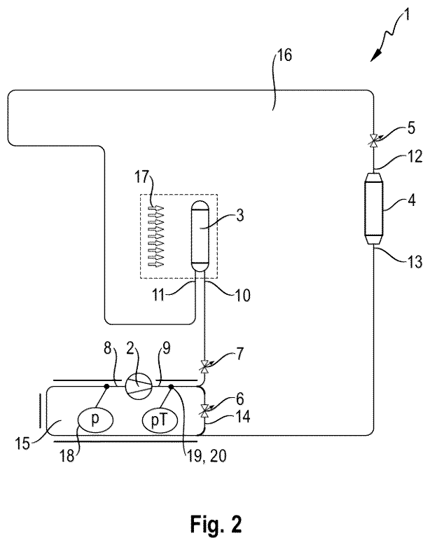

FIG. 2 shows another schematic drawing of the heating circuit for illustrating the method obtained with the invention,

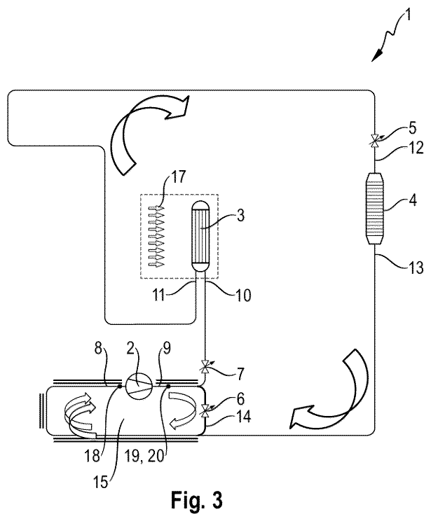

FIG. 3 shows another schematic drawing of the heating circuit for illustrating the method obtained with the invention,

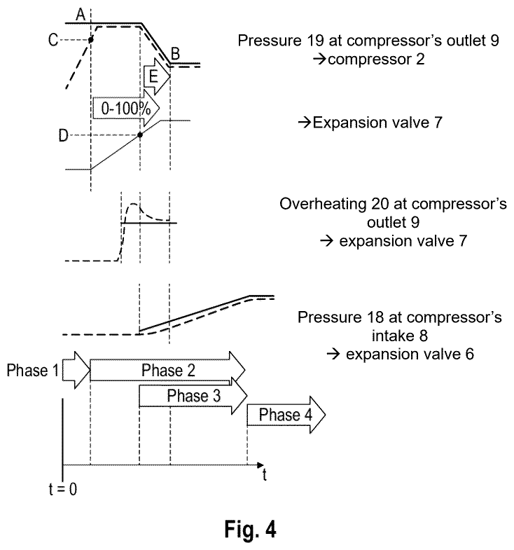

FIG. 4 shows a diagram illustrating the method obtained with the invention and the heating circuit obtained with the invention, and

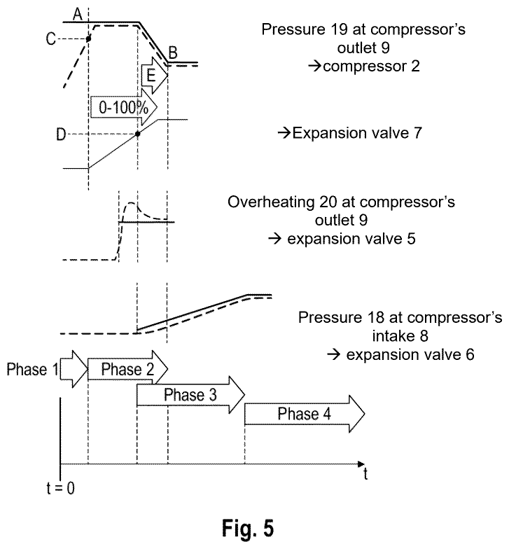

FIG. 5 shows another diagram illustrating the method obtained with the invention and the heating circuit obtained with the invention.

FIGS. 1, 2, and 3 show different illustrations of a heating circuit 1 for a motor vehicle.

This heating circuit 1 is used to heat the vehicle interior, i.e. the passenger compartment, and can also be used to heat other units, such as batteries, etc.

The heating circuit 1 contains a compressor 2 that pressurizes refrigerant circulating in the heating circuit 1.

There is also a first heat exchanger 3 that functions as a heater, and a second heat exchanger 4 functioning as a chiller. The first heat exchanger 3 is downstream of the compressor 2, and the second heat exchanger 4 is downstream of the first heat exchanger 3 in the heating circuit 1.

There are also at least two expansion valves 5, 6. In the exemplary embodiments shown in FIGS. 1 to 3, there are actually three expansion valves 5, 6, 7. These expansion valves 5, 6, 7 can be regulated.

The compressor 2 has an intake 8, and an outlet 9. The first heat exchanger 3 has a first intake 10 and first outlet 11, and the second heat exchanger 4 has a second intake 12 and second outlet 13.

In FIG. 1, the compressor's outlet 9 is connected to the first intake 10, the first outlet 11 is connected to the second intake 12, and the second outlet 13 is connected to the compressor's intake 8.

There is a first expansion valve 5 upstream of the second heat exchanger 4, and a bypass is formed between the compressor's outlet 9 and the compressor's intake 8, in which there is a second expansion valve 6.

The refrigerant can therefore circulate in a bypass circuit 15 and/or a heat exchanger circuit 16.

It is particularly advantageous when there is a third expansion valve 7, which is then downstream of the compressor 2 and upstream of the first heat exchanger 3.

Depending on the state of the expansion valves 5, 6, 7, the refrigerant flows through the bypass circuit 15 and/or the heat exchanger circuit 16. Refrigerant flows substantially through just the bypass circuit 15 in FIG. 2, and through both the heat exchanger circuit 16 and the bypass circuit 15 in FIG. 3.

The heating circuit 1 is operated with a liquid refrigerant, in particular that does not contain fluorides, e.g. CO₂, propane, R134, R1234yf, etc.

The first heat exchanger 3 in the exemplary embodiments in FIGS. 1 to 3 is a refrigerant/air heat exchanger, in which the air 17 supplied to the vehicle cab is thermally treated, i.e. heated. Both the refrigerant and the air 17 flow through the first heat exchanger 3 to heat the air 17.

The first heat exchanger 3 could also be a refrigerant/liquid heat exchanger connected to a liquid circuit that contains a liquid/air heat exchanger for heating the air supply for a vehicle cab. It may also be advantageous if this liquid is a water-based coolant.

The second heat exchanger 4 is preferably a chiller in the form of a refrigerant/liquid heat exchanger in which the liquid is preferably a water-based coolant. This coolant can then be used in a separate circuit to heat another unit, e.g. a battery, etc.

In the method for controlling a heating circuit 1 that has the features of the heating circuit 1 obtained with the invention, the compressor 2, first expansion valve 5, second expansion valve 6, and/or third expansion valve 7 are used to control the heating circuit 1. This method is divided into different phases and the heating circuit is operated differently in these various phases.

The heating circuit 1 is controlled in different phases, in particular in at least a first, preparatory phase, a second, initial heating phase, a third, initial heating phase, and a fourth, continuous operating phase.

In the first phase, the preparatory phase, shown in FIG. 2, the pressure 18 is limited by the compressor's rotational rate prior to the compressor 2, to ensure that this pressure 18 does not fall below a minimum prior to the compressor 2, the second expansion valve 6 is partially closed, and the third expansion valve 7, if there is one, is closed, or nearly closed. Consequently, the refrigerant only flows through the bypass circuit 15, which functions as an initial circuit. The first expansion valve 5 is partially closed in this case, and the third expansion valve 7 is nearly closed, or closed, if there is one, as is also shown in FIG. 2.

In the second phase, shown in FIG. 3, the initial heating phase, the first expansion valve 5 regulates overheating 20 at the compressor's outlet 9, the second expansion valve 6 is partially open, the third expansion valve 7, if there is one, starts to open, and the compressor 2 regulates the heat output.

In the third phase, the initial heating phase, where the target heat output is nearly reached, the first expansion valve 5 regulates overheating 20 at the compressor's outlet 9, the second expansion valve 6 is partially open and alters the flow in order to regulate the pressure 18 at the compressor's intake 8, the third expansion valve 7 is open, and the heat output is regulated by the compressor's rotational rate.

In the fourth phase, the continuous operating phase, the first expansion valve 6 regulates overheating 20 at the compressor's outlet 9, the second valve 6 regulates the pressure 18 at the compressor's intake 8, the third expansion valve 7 is open, and the heat output is regulated by the compressor's rotational rate.

If there is no third expansion valve 7, the warm-up is not as fast, and it is advantageous if the air 17 does not flow very much, or at all, over the first heat exchanger 3 in this phase.

FIGS. 4 and 5 show different illustrations of the temporal sequence of the four phases in different exemplary embodiments.

FIG. 4 shows the temporal sequence of the four phases for different values over time.

In the upper part, the refrigerant pressure 19 at the compressor's outlet 9 is plotted over time t.

In the second part from the top, the opening cross section of the third expansion valve 7 is plotted over time t.

In the third part from the top, overheating 20 at the compressor's outlet 2 represents the state of first expansion valve 5 plotted over time t.

In the bottom part, the pressure 18 at the compressor's intake 8 represents the state of the second expansion valve 6 as EXV2 plotted over time t.

At the very bottom, arrows indicate the four phases. The method starts with the first phase, referred to as “Phase 1.”

After starting the first phase and reaching the value C, the control forms a closed-loop regulation, with a target value A for the pressure 19 at the compressor's outlet 9, such that the pressure 19 at this outlet 9 increases, as indicated by the broken line in the upper part of FIG. 4. Once the value C has been reached, in which C<A, the first phase is complete and the second phase begins. By way of example, A=C+2 bar.

The third expansion valve 7 opens slowly at the start of the second phase such that it does not have an excessive impact on the pressure 19 at the compressor's outlet 9. The pressure at the compressor's outlet 9 should not drop more than 2 bar.

The opening of the first expansion valve 5 is regulated when the overheating at the compressor's outlet 9 is greater than 13 K, as shown by the overheating 20 curve in the third part of FIG. 4 from the top. The first expansion valve 5 is used to regulate the overheating 20 at the compressor's outlet 9.

The opening of the second expansion valve 6 is regulated when the extent of the opening of the third expansion valve 7 is greater than D. The target value for the pressure 18 at the compressor's intake 8 increases slowly, e.g. at 1 bar/minute, until reaching the end value. The actual value follows the target value.

As the second expansion valve 6 starts to open at the beginning of the third phase, the pressure 19 at the compressor's outlet 9 drops to a necessary end value B.

The illustration shows that the second and third phases take place in parallel to some extent, in that the second phase starts earlier than the third, and they end at the same time.

FIG. 5 shows a temporal sequence for the four phases for different values plotted over time t, similar to FIG. 4.

In the upper part, the refrigerant pressure 19 at the compressor's outlet 9 is plotted over time t.

In the second part from the top, the opening cross section of the third expansion valve 7 is plotted over time t.

In the third part from the top, overheating 20 at the compressor's outlet 2 represents the state of first expansion valve 5 plotted over time t.

In the bottom part, the pressure 18 at the compressor's intake 8 represents the state of the second expansion valve 6 plotted over time t.

At the very bottom, arrows indicate the four phases. The method starts with the first phase, referred to as “Phase 1.”

After starting the first phase and reaching the value C, the control forms a closed-loop regulation, with a target value A for the pressure 19 at the compressor's outlet 9, such that the pressure 19 at this outlet 9 increases, as indicated by the broken line in the upper part of FIG. 5. Once the value C has been reached, in which C<A, the first phase is complete and the second phase begins. By way of example, A=C+2 bar.

The third expansion valve 7 opens slowly at the start of the second phase such that it does not have an excessive impact on the pressure 19 at the compressor's outlet 9. The pressure at the compressor's outlet 9 should not drop more than 2 bar.

The opening of the first expansion valve 5 is regulated when the overheating at the compressor's outlet 9 is greater than 13 K, as shown by the overheating 20 curve in the third part of FIG. 4 from the top. The first expansion valve 5 is used to regulate the overheating 20 at the compressor's outlet 9.

The opening of the first expansion valve 5 is regulated when the overheating at the compressor's outlet 9 is greater than 13 K, as shown by the overheating 20 curve in the third part of FIG. 5 from the top. The first expansion valve 5 is used to regulate the overheating 20 at the compressor's outlet 9.

The opening of the second expansion valve 6 is regulated when the extent of the opening of the third expansion valve 7 is greater than D. The target value for the pressure 18 at the compressor's intake 8 increases slowly, e.g. at 1 bar/minute, until reaching the end value. The actual value follows the target value.

As the second expansion valve 6 starts to open at the beginning of the third phase, the pressure 19 at the compressor's outlet 9 drops to a necessary end value B.

FIG. 5 clearly shows that the second and third phases take place in parallel to some extent. In this case, the second phase ends significantly earlier than the third phase, when the pressure 19 at the compressor's outlet 9 reaches the value B.

The values specified herein are examples for the refrigerant R1234yf. With other refrigerants, other values may be relevant.

These values are different for each phase, as can be seen by the value B for the pressure 19 at the compressor's outlet 9. This value B is defined in the first phase, for example, by the air conditioner setting. The value C can be selected on the basis of B. B in this case is defined as C<B+2 bar. Alternatively: B−2 bar<C<B+4 bar.

In the second phase: C+1 bar<A<C+3 bar. B is the same in the second phase as in the first.

For the overheating 20 at the compressor's outlet 9:

$$\begin{matrix}8 K < overheating < 15 K \\ or \\ 6 K < overheating < 20 K .\end{matrix}$$

In the third phase, the extent to which the third expansion valve is open at the start is 70% or 50%, in particular more than 70% or more than 50%.

The final pressure 18 at the compressor's intake 8 for the second expansion valve 6 is preferably between 3 and 6 bar, preferably between 2 and 10 bar.

The pressure 19 at the compressor's outlet 9 in the fourth phase is the same as in the first phase. The pressure 18 at the compressor's intake 8 is preferably the same as in the third phase. The overheating 20 in the fourth phase is preferably the same as in the second phase.

The specification can be readily understood with reference to the following Numbered Paragraphs:
Numbered Paragraph 1. A heating circuit (1), specifically for a motor vehicle, which has a compressor (2), a first heat exchanger (3) functioning as a heater, a second heat exchanger (4) functioning as a chiller, at least two expansion valves (5, 6), wherein the compressor (2) has an intake (8) and an outlet (9), the first heat exchanger (3) has a first intake (10) and first outlet (11), and the second heat exchanger (4) has a second intake (12) and second outlet (13), wherein the outlet (9) on the compressor (2) is connected to the first intake (10), the first outlet (11) is connected to the second intake (12), and the second outlet (13) is connected to the intake (8) on the compressor (2), wherein there is a first expansion valve (5) upstream of the second heat exchanger (4) and wherein a bypass (14) is formed between the outlet (9) and the intake (8) on the compressor (2), in which the second expansion valve (6) is located.
Numbered Paragraph 2. The heating circuit (1) according to Numbered Paragraph 1, characterized in that there is a third expansion valve (7) downstream of the compressor (2) and upstream of the first heat exchanger (3).
Numbered Paragraph 3. The heating circuit (1) according to Numbered Paragraph 1 or 2, characterized in that the heating circuit (1) can be operated with a liquid such as a refrigerant, in particular that contains no fluorides, e.g. CO₂, propane, R134, R1234yf, etc.
Numbered Paragraph 4. The heating circuit (1) according to any of the preceding Numbered Paragraphs, characterized in that the first heat exchanger (3) is a refrigerant/air heat exchanger that thermally treats air (17), in particular for a vehicle cab, specifically heating it.
Numbered Paragraph 5. The heating circuit (1) according to any of the preceding Numbered Paragraphs 1 to 3, characterized in that the first heat exchanger (3) is a refrigerant/liquid heat exchanger that is connected to a liquid circuit containing a liquid/air heat exchanger for heating the air supplied to a vehicle cab.
Numbered Paragraph 6. The heating circuit (1) according to Numbered Paragraph 5, characterized in that the liquid is a refrigerant, in particular a water-based refrigerant.
Numbered Paragraph 7. The heating circuit (1) according to any of the preceding Numbered Paragraphs, characterized in that the second heat exchanger (4) is a refrigerant/liquid heat exchanger that forms a chiller, wherein the liquid is preferably a coolant, in particular a water-based coolant.
Numbered Paragraph 8. A method for controlling a heating circuit (1) that has the features of any of the preceding Numbered Paragraphs, characterized in that the compressor (2), first expansion valve (5), second expansion valve (6), and potentially the optional third expansion valve (7), are used to regulate the heating circuit (1).
Numbered Paragraph 9. The method according to Numbered Paragraph 8, characterized in that the heating circuit (1) is regulated in different phases, in particular in at least a first, preparatory phase, a second, initial heating phase, a third, initial heating phase, and a fourth, continuous operating phase.
Numbered Paragraph 10. The method according to Numbered Paragraph 9, characterized in that in the first phase, the preparatory phase, the pressure (18) at the intake (8) on the compressor (2) is limited by the compressor's rotational rate, wherein the second expansion valve (6) is partially closed.
Numbered Paragraph 11. The method according to Numbered Paragraph 10, characterized in that the first expansion valve (5) is partially closed, and the optional third expansion valve (7) is closed or nearly closed.
Numbered Paragraph 12. The method according to Numbered Paragraph 9, 10, or 11, characterized in that in the second phase, the initial heating phase, the first expansion valve (5) regulates the overheating (20) at the outlet (9) on the compressor (2), the second expansion valve (6) is partially closed, and the optional third expansion valve (7) starts to open, wherein the compressor (2) regulates the heat output.
Numbered Paragraph 13. The method according to Numbered Paragraph 9, 10, 11, or 12, characterized in that in the third phase, the initial heating phase, once the target heat output is reached, the first expansion valve (5) regulates overheating (20) at the outlet (9) on the compressor (2), the second expansion valve (6) starts to close to regulate the pressure (18) at the intake (9) on the compressor (2), and the third expansion valve (7) is open, wherein the heat output is regulated by the compressor's rotational rate.
Numbered Paragraph 14. The method according to Numbered Paragraph 9, 10, 11, 12, or 13, characterized in that in the fourth phase, the continuous operating phase, the first expansion valve (5) regulates overheating (20) at the outlet (9) on the compressor (2), the second expansion valve (6) regulates the pressure (18) at the intake (8) on the compressor (2), and the optional third expansion valve (7) is open, wherein the heat output is regulated by the compressor's rotational rate.
Numbered Paragraph 15. The method according to any of the preceding Numbered Paragraphs 8 to 14, characterized in that the target value A for the initial pressure (19) at the outlet (9) on the compressor (2) is:

$$C + 1 bar < A < C + 3 bar$$

where C is the pressure (19) at the outlet (9) on the compressor (2) at the end of the first phase.
Numbered Paragraph 16. The method according to any of the preceding Numbered Paragraphs 8 to 15, characterized in that the value C for the pressure (19) at the outlet (9) on the compressor (2) at the end of the first phase is:

$$\begin{matrix}C < B + 2 bar \\ or \\ B - 2 bar < C < B + 4 bar\end{matrix}$$

where B is a predefined specific value for the regulating circuit forming the final value for the pressure (19) at the outlet (9) on the compressor (2).
Numbered Paragraph 17. The method according to any of the preceding Numbered Paragraphs 8 to 16, characterized in that the value D, forming the opening value for the third expansion valve (7) at the start of the third phase is:

$$\begin{matrix}D > 50 \% \\ or \\ D > 70 \% .\end{matrix}$$

List of Reference Symbols

| | |
|---|---|
| 1 | heating circuit |
| 2 | compressor |
| 3 | first heat exchanger |
| 4 | second heat exchanger |
| 5 | expansion valve |
| 6 | expansion valve |
| 7 | expansion valve |
| 8 | compressor's intake |
| 9 | compressor's outlet |
| 10 | first intake |
| 11 | first outlet |
| 12 | second intake |
| 13 | second outlet |
| 14 | bypass |
| 15 | bypass circuit |
| 16 | heat exchanger circuit |
| 17 | air |
| 18 | pressure at compressor's intake |
| 19 | pressure at compressor's outlet |
| 20 | overheating at compressor's outlet |

1-17. (canceled)

18. A heating circuit for a motor vehicle, comprising: a compressor, a first heat exchanger functioning as a heater, a second heat exchanger functioning as a chiller, and at least two expansion valves,
wherein the compressor comprises an intake and an outlet, the first heat exchanger comprises a first intake and first outlet, and the second heat exchanger comprises a second intake and second outlet,
wherein the outlet on the compressor is connected to the first intake, the first outlet is connected to the second intake, and the second outlet is connected to the intake on the compressor,
further comprising a first expansion valve upstream of the second heat exchanger and wherein a bypass is formed between the outlet and the intake on the compressor, in which the second expansion valve is located.

19. The heating circuit according to claim 18, further comprising a third expansion valve downstream of the compressor and upstream of the first heat exchanger.

20. The heating circuit according to claim 18, wherein the heating circuit is configured to be operated with a refrigerant that contains no fluorides.

21. The heating circuit according to claim 18, wherein the first heat exchanger is a refrigerant/air heat exchanger that heats air for a vehicle cab.

22. The heating circuit according to claim 18, wherein the first heat exchanger is a refrigerant/liquid heat exchanger that is connected to a liquid circuit containing a liquid/air heat exchanger for heating the air supplied to a vehicle cab.

23. The heating circuit according to claim 22, wherein the liquid is a refrigerant that is a water-based refrigerant.

24. The heating circuit according to claim 18, wherein the second heat exchanger is a refrigerant/liquid heat exchanger that forms a chiller, wherein the liquid is a water-based coolant.

25. A method for controlling a heating circuit that is constructed according to claim 18, wherein the compressor, first expansion valve, second expansion valve, are used to regulate the heating circuit.

26. The method according to claim 25, wherein the heating circuit is regulated in a plurality of phases, the phases comprise at least a first, preparatory phase, a second, initial heating phase, a third, initial heating phase, and a fourth, continuous operating phase.

27. The method according to claim 26, wherein during the first phase and the preparatory phase, a pressure at the intake on the compressor is limited by the compressor's rotational rate, wherein the second expansion valve is partially closed.

28. The method according to claim 27, wherein the first expansion valve is partially closed.

29. The method according to claim 26, wherein in the second phase, and the initial heating phase, the first expansion valve regulates the overheating at the outlet on the compressor, the second expansion valve is partially closed, wherein the compressor regulates the heat output.

30. The method according to claim 26, wherein in the third phase, and in the initial heating phase, once the target heat output is reached, the first expansion valve regulates overheating at the outlet on the compressor, the second expansion valve starts to close to regulate the pressure at the intake on the compressor, wherein the heat output is regulated by the compressor's rotational rate.

31. The method according to claim 26, wherein in the fourth phase, and in the continuous operating phase, the first expansion valve regulates overheating at the outlet on the compressor, the second expansion valve regulates the pressure at the intake on the compressor, wherein the heat output is regulated by the compressor's rotational rate.

32. The method according to claim 26, wherein a target value (A) for an initial pressure (19) at the outlet on the compressor is:
$$C + 1 bar < A < C + 3 bar$$
where (C) is a pressure (19) at the outlet on the compressor at the end of the first phase.

33. The method according to claim 26, wherein a value (C) for a pressure (19) at the outlet on the compressor at the end of the first phase is:
$$\begin{matrix}C < B + 2 bar \\ or \\ B - 2 bar < C < B + 4 bar\end{matrix}$$
where (B) is a predefined specific value for the regulating circuit forming the final value for the pressure (19) at the outlet on the compressor.

34. The method according to claim 26, wherein a value D, forming the opening value for the third expansion valve at the start of the third phase is:
$$\begin{matrix}D > 50 \% \\ or \\ D > 70 \% .\end{matrix}$$

35. The heating circuit according to claim 20, wherein the heating circuit is configured to be operated with the refrigerant that is one of CO₂, propane, R134, or R1234yf.

36. A method for controlling a heating circuit that is constructed according to claim 25, wherein further comprising a third expansion valve, wherein the third expansion valve is used to regulate the heating circuit.
